(19) United States
(12) Patent Application Publication
(10) Pub. No.: US 2002/0009203 A1
(43) Pub. Date: Jan. 24, 2002

(54) Method and apparatus for voice signal extraction

(76) Inventor: Gamze Erten, Okemos, MI (US)

Correspondence Address: Mark D. Chuey, Brooks & Kushman P.C., Twenty-Second Floor, 1000 Town Center, Southfield, MI, 48075, US

(21) Appl. No.: 09/823,586

(22) Filed: Mar. 30, 2001

Related U.S. Application Data
(60) Provisional application No. 60/193,779, filed on Mar. 31, 2000.

(51) Int. Cl. H04R 3/00; H04B 15/00

(52) U.S. Cl. 381/92; 381/94.1

(57) ABSTRACT

A method is provided for positioning the individual elements of a microphone arrangement including at least two such elements. The spacing among the microphone elements supports the generation of numerous combinations of the signal of interest and a sum of interfering sources. Use of the microphone element placement method leads to the formation of many types of microphone arrangements, comprising at least two microphone elements, and provides the input data to a signal processing system for sound discrimination. Many examples of these microphone arrangements are provided, some of which are integrated with everyday objects. Also, enhancements and extensions are provided for a signal separation-based processing system for sound discrimination, which uses the microphone arrangements as the sensory front end.

### RELATED APPLICATIONS

This application claims the benefit of U.S. Provisional Application No. 60/193,779, filed Mar. 31, 2000, incorporated herein by reference.

### GOVERNMENT LICENSE RIGHTS

The United States Government may have certain rights in some aspects of the invention claimed herein, as the invention was made with United States Government support under award/contract number F33615-98-C-1230 issued by Department of Defense Small Business Innovative Research (SBIR) Program.

### BACKGROUND

1. Field of the Invention

This present invention relates to the field of noise reduction in speech-based systems. In particular, the present invention relates to the extraction of a target audio signal from a signal environment.

2. Description of Related Art

Speech-based systems and technologies are becoming increasingly commonplace. Among some of the more popular deployments are cellular telephones, hand-held computing devices, and systems that depend upon speech recognition functionality. Accordingly, as speech based technologies become increasingly commonplace, the primary barrier to the proliferation and user acceptance of such speech-based technologies are the noise or interference sources that contaminate the speech signal and degrade the performance and quality of speech processing results. The current commercial remedies, such as noise cancellation filters and noise canceling microphones have been inadequate to deal with a multitude of real world situations, at best providing limited improvement, and at times making matters worse.

Noise contamination of a speech signal occurs when sound waves emanating from objects present in the environment, including other speech sources, mix and interfere with the sound waves produced by the speech source of interest. Interference occurs along three dimensions. These dimensions are time, frequency, and direction of arrival. The time overlap occurs as a result of multiple sound waves registering simultaneously at a receiving transducer or device. Frequency or spectrum overlap occurs and is particularly troublesome when mixing the sound sources have common frequency components. The overlap in direction of arrival arises because the sound sources may occupy any position around the receiving device and thus may exhibit similar directional attributes in the propagation of the corresponding sound waves.

An overlap in time results in the reception of mixed signals at the acoustic transducer or microphone. The mixed signal contains a combination of attributes of the sound sources, degrading both sound quality as well as the result of subsequent processing of the signal. Typical solutions to time overlap discriminate between signals that overlap in time based on distinguishing signal attributes in frequency, content, or direction of arrival. However, the typical solutions can not distinguish between signals that overlap in time, spectrum, or direction of arrival simultaneously.

The typical technologies may be generally categorized in two generic groups: a spatial filter group; and, a frequency filter group. The spatial filter group employs spatial filters that discriminate between signals based on the direction of arrival of the respective signals. Correspondingly, the frequency filter group employs frequency filters that discriminate between signals based on the frequency characteristics of the respective signals.

Regarding frequency filters, when signals originating from multiple sources do not overlap in spectrum, and the spectral content of the signals is known, a set of frequency filters, such as low pass filters, bandpass filters, high pass filters, or some combination of these can be used to solve the problem. Frequency filters are used to filter out the frequency components that are not components of the desired signal. Thus, frequency filters provide limited improvement in isolating the particular desired signal by suppressing the accompanying surrounding interference audio signals. Again, however, the typical frequency filter-based solutions can not distinguish between signals that overlap in frequency content, i.e., spectrum.

An example frequency based method of noise suppression is spectral subtraction, which records noise content during periods when the speaker is silent and subtracts the spectrum of this noise content from the signal recorded when the speaker is active. This may produce unnatural effects and inadvertently remove some of the speech signal along with the noise signal.

When signals originating from multiple sources have little or no overlap in their direction of arrival and the direction of arrival of the signal of interest is known, the problem can be solved to a great extent with the use of spatial filters. Many array microphones utilize spatial filtering techniques. Directional microphones, too, provide some attenuation of signals arriving from the non-preferred direction of the microphone. For example, by holding a directional microphone to the mouth, a speaker can make sure the directional microphone predominantly picks up his/her voice. The directional microphone cannot solve the problems arising from overlap in time and spectrum, however.

As such, current technologies suppress noise, like many other competing noise cancellation technologies, which does not necessarily result in the isolation of the desired signal, as certain parts of the desired signal are susceptible to actually being filtered out or corrupted during the filtering process. Moreover, in order to operate within design parameters, the typical technologies generally require that the interfering sounds either arrive from different directions, or contain different frequency components. As such, the current technologies are limited to a prescribed domain of acoustical and environmental conditions.

Consequently, the typical techniques used to produce clean audio signals have shortfalls that do not address a multitude of real world situations which require the simultaneous consideration of all environments (e.g., overlap in time, overlap in direction of arrival, overlap in spectrum). Thus, an apparatus and method is needed that addresses the multitude of real world noise situations by considering all types of signal interference.

### SUMMARY

A method is provided for positioning the individual elements of a microphone arrangement including at least two microphone elements. Upon estimating the potential positions of the sources of signals of interest as well as potential positions of interfering signal sources, a set of criteria are defined for acceptable performance of a signal processing system. The signal processing system distinguishes between the signals of interest and signals which interfere with the signals of interest. After defining the criteria, the first element of the microphone arrangement is positioned in a convenient location. The defined criteria place constraints upon the placement of the subsequent microphone elements. For a two microphone arrangement, the criteria may include: avoidance of microphone placements which lead to identical signals being registered by the two microphone elements; and, positioning microphone elements so that the interfering sound sources registered at the two microphone elements have similar characteristics. For microphone arrangements including more than two microphone elements, some of the criteria may be relaxed, or additional constraints may be added. Regardless of the number of microphone elements in the microphone arrangement, subsequent elements of the microphone arrangement are positioned in a manner that assures adherence to the defined set of criteria for the particular number of microphones.

The positioning methods are used to provide numerous microphone arrays or arrangements. Many examples of such microphone arrangements are provided, some of which are integrated with everyday objects. Further, these methods are used in providing input data to a signal processing system or speech processing system for sound discrimination. Moreover, enhancements and extensions are provided for a signal processing system or speech processing system for sound discrimination that uses the microphone arrangements as a sensory front end. The microphone arrays are integrated into a number of electronic devices.

The descriptions provided herein are exemplary and explanatory and are intended to provide examples of the claimed invention.

### BRIEF DESCRIPTION OF THE FIGURES

The accompanying figures illustrate embodiments of the claimed invention.

In the figures:

FIG. 1 is a flow diagram of a method for determining microphone placement for use with a voice extraction system of an embodiment.

FIG. 2 shows an arrangement of two microphones of an embodiment that satisfies the placement criteria.

FIG. 3 is a detail view of the two microphone arrangement of an embodiment.

FIGS. 4A and 4B show a two-microphone arrangement of a voice extraction system of an embodiment.

FIGS. 5A and 5B show alternate two-microphone arrangements of a voice extraction system of an embodiment.

FIGS. 6A and 6B show additional alternate two-microphone arrangements of a voice extraction system of an embodiment.

FIGS. 7A and 7B show further alternate two-microphone arrangements of a voice extraction system of an embodiment.

FIG. 8 is a top view of a two-microphone arrangement of an embodiment showing multiple source placement relative to the microphones.

FIG. 9 shows microphone array placement of an embodiment on various hand-held devices.

FIG. 10 shows microphone array placement of an embodiment in an automobile telematic system.

FIG. 11 shows a two-microphone arrangement of a voice extraction system of an embodiment mounted on a pair of eye glasses or goggles.

FIG. 12 shows a two-microphone arrangement of a voice extraction system of an embodiment mounted on a cord.

FIGS. 13A-C show three two-microphone arrangements of a voice extraction system of an embodiment mounted on a pen or other writing or pointing instrument.

FIG. 14 shows numerous two-microphone arrangements of a voice extraction system of an embodiment.

FIG. 15 shows a microphone array of an embodiment including more than two microphones.

FIG. 16 shows another microphone array of an embodiment including more than two microphones.

FIG. 17 shows an alternate microphone array of an embodiment including more than two microphones.

FIG. 18 shows another alternate microphone array of an embodiment including more than two microphones.

FIGS. 19A-C show other alternate microphone arrays of an embodiment comprising more than two microphones.

FIGS. 20A and 20B show typical feedforward and feedback signal separation architectures.

FIG. 21A shows a block diagram of a representative voice extraction architecture of an embodiment receiving two inputs and providing two outputs.

FIG. 21B shows a block diagram of a voice extraction architecture of an embodiment receiving two inputs and providing five outputs.

FIGS. 22A-D show four types of microphone directivity patterns used in an embodiment.

### DETAILED DESCRIPTION

A method and system for performing blind signal separation in a signal processing system is disclosed in U.S. application Ser. No. 09/445,778, “Method and Apparatus for Blind Signal Separation,” incorporated herein by reference. Further, this signal processing system and method is extended to include feedback architectures in conjunction with the state space approach in U.S. application Ser. No. 09/701,920, “Adaptive State Space Signal Separation, Discrimination and Recovery Architectures and Their Adaptations for Use in Dynamic Environments,” incorporated herein by reference. These pending patents disclose general techniques for signal separation, discrimination, and recovery that can be applied to numerous types of signals received by sensors that can register the type of signal received. Also disclosed is a sound discrimination system, or voice extraction system, using these signal processing techniques. The process of separating and capturing a single voice signal of interest free, at least in part, of other sounds or less encumbered or masked by other sounds is referred to herein as “voice extraction”.

The voice extraction system of an embodiment isolates a single voice signal of interest from a mixed or composite environment of interfering sound sources so as to provide pure voice signals to speech processing systems including, for example, speech compression, transmission, and recognition systems. Isolation includes, in particular, the separation and isolation of the target voice signal from the sum of all sounds present in the environment and/or registered by one or more sound sensing devices. The sounds present include background sounds, noise, multiple speaker voices, and the voice of interest, all overlapping in time, space, and frequency.

The single voice signal of interest may be arriving from any direction, and the direction may be known or unknown. Moreover, there may be more than a single signal source of interest active at any given time. The placement of sound or signal receiving devices, or microphones, can affect the performance of the voice extraction system, especially in the context of applying blind signal separation and adaptive state space signal separation, discrimination and recovery techniques to audio signal processing in real world acoustic environments. As such, microphone arrangement or placement is an important aspect of the voice extraction system.

In particular, the voice extraction system of an embodiment distinguishes among interfering signals that overlap in time, frequency, and direction of arrival. This isolation is based on inter-microphone differentials in signal amplitude and the statistical properties of independent signal sources, a technique that is in contrast to typical techniques that discriminate among interfering signals based on direction of arrival or spectral content. The voice extraction system functions by performing signal extraction not just on a single version of the sound source signals, but on multiple delayed versions of each of the sound signals. No spectral or phase distortions are introduced by this system.

The use of signal separation for voice extraction implicates several implementation issues in the design of receiving microphone arrangements or arrays. One issue involves the type and arrangement of microphones used in sensing a single voice signal of interest (as well as the interfering sounds), either alone, or in conjunction with voice extraction, or with other signal processing methods. Another issue involves a method of arranging two or more microphones for voice extraction so that optimum performance is achieved. Still another issue is determining a method for buffering and time delaying signals, or otherwise processing received signals so as to maintain causality. A further issue is determining methods for deriving extensions of the core signal processing architecture to handle underdetermined systems, wherein the number of signal sources that can be discriminated from other signals is greater than the number of receivers. An example is when a single source of interest can be extracted from the sum of three or more signals using only two sound sensors.

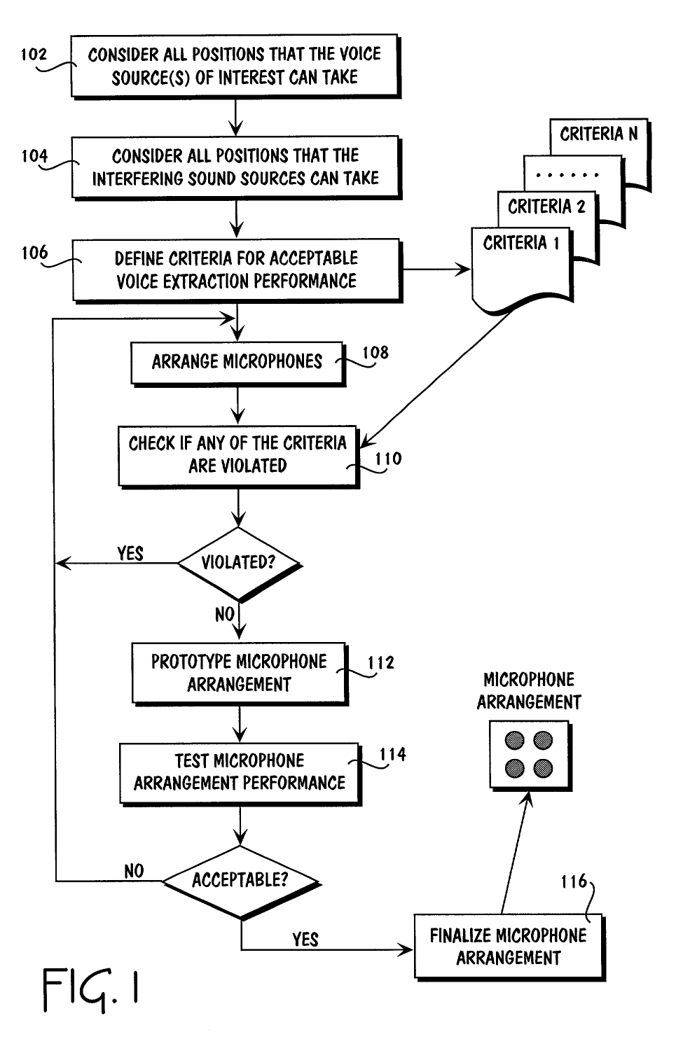

FIG. 1 is a flow diagram of a method for determining microphone placement for use with a voice extraction system of an embodiment. Operation begins by considering all positions that the voice source or sources or interest can take in a particular context 102. All possible positions are also considered that the interfering sound source or sources can take in a particular context 104. Criteria are defined for acceptable voice extraction performance in the equipment and settings of interest 106. A microphone arrangement is developed, and the microphones are arranged 108. The microphone arrangement is then compared with the criteria to determine if any of the criteria are violated 110. If any criteria are violated then a new arrangement is developed 108. If no criteria are violated, then a prototype microphone arrangement is formed 112, and performance of the arrangement is tested 114. If the prototype arrangement demonstrates acceptable performance then the prototype arrangement is finalized 116. Unacceptable prototype performance leads to development of an alternate microphone arrangement 108.

Two-microphone systems for extracting a single signal source are of particular interest as many audio processing systems, including the voice extraction system of an embodiment, use at least two microphones or two microphone elements. Furthermore, many audio processing systems only accommodate up to two microphones. As such, a two-microphone placement model is now described.

Two microphones provide for the isolation of, at most, two source signals of interest at any given time. In other words, two inputs from two sensors, or microphone elements, imply that the generic voice extraction system based on signal separation can generate two outputs. The extension techniques described herein provide for generation of a larger or smaller number of outputs.

Since in many cases there may be numerous interfering sources and a single signal of interest, one is often interested in isolating a single sound source (e.g., the voice of the user of a device, such as a cellular phone) from all other interfering sources. In this specific case, which also happens to have very broad applicability, a number of placement criteria are considered. These placement criteria are derived from the fact that there are two microphones in the arrangement and that the sound source and interference sources have many possible combinations of positions. A first consideration is the need to have different linear combinations of the single source of interest and the sum of all interfering sources. Another consideration is the need to register the sum of interfering sources as similarly as possible, so that the sum registered by one microphone closely resembles the sum registered by the other microphone. A third consideration is the need to designate one of the two output channels as the output that most closely captures the source of interest.

The first placement criteria arises as a result of the systems singularity constraint. The system fails when the two microphones provide redundant information. Although true singularity is hard to achieve in the real world, numerical evaluation becomes more cumbersome and demanding as the inputs from the two sensors, which register combinations of the voice signal of interest and all other sounds, approach the point of singularity. Therefore, for optimum performance, the microphone arrangement should steer as far away from singularity as possible by minimizing the singularity zone and the probability that a singular set of outputs will be produced by the two acoustic sensors. It should be noted that the singularity constraint is surmountable with more sophisticated numerical processing.

The second placement criteria arises as a result of the presence of many interfering sound sources that contaminate the sound signal from a single source of interest. This problem requires re-formulation of the classic presentation of the signal separation problem, which provides a constrained framework, where only two distinct sources can be distinguished from one another with two microphones. In many real world situations, rather than a second single interfering source, there is present a sum of many interfering sources. A reversion back to the classic problem statement could be made if the sum of many sources would act as a single source for both microphones. Given that the position of the source of interest is often much closer than the positions the interfering sources can assume, this is a reasonable approximation. Since the interfering sources are very often further away than the single source of interest, their inter-microphone differences in amplitude can be much lower than the inter-microphone differences in amplitude generated by the single source of interest, which is assumed to be much closer to the microphones.

The third placement criteria is explained as follows. In the context of many applications, voice extraction must be implemented as a signal processing system composed of finite impulse response (FIR) and/or infinite impulse response (IIR) filters. To be realizable as an analog or digital signal processing system composed of FIR or IIR filters, a system must obey causality. One of the restrictions of causality is that it prevents the estimation of source signal values not yet obtained, i.e., signal values beyond time instant (t). That is, filters can only estimate source values for the time instants (t-δ) where δ is nonnegative. Consequently, a “source of interest” microphone is designated with reference to time so that it always receives the source of interest signal first. This microphone will receive the time (t) instant of the source of interest signal; whereas the second microphone receives a time delayed (t-δ) instant signal. In this case, δ will be determined by the spacing between the two microphones, the position of the source of interest and the velocity of the propagating sound wave. This requirement is reinforced further with feedback architectures, where the source signal is found by subtracting off the interfering signal.

Further analysis and experimentation with a set of specific microphone types and directivity patterns, placement position, and attitude, supports the establishment of a set of relationships among the named parameters and the degree of separation or success of voice extraction. These three criteria are used as guides in searching this space.

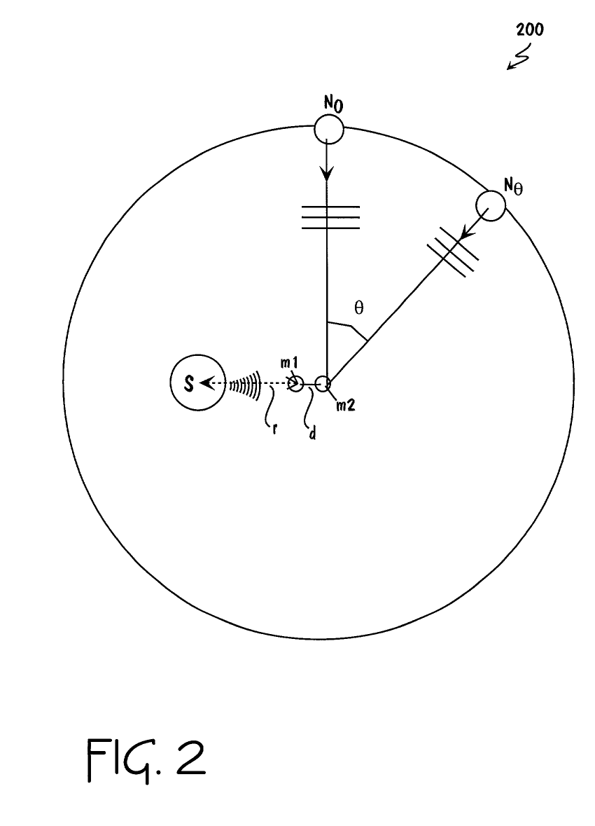

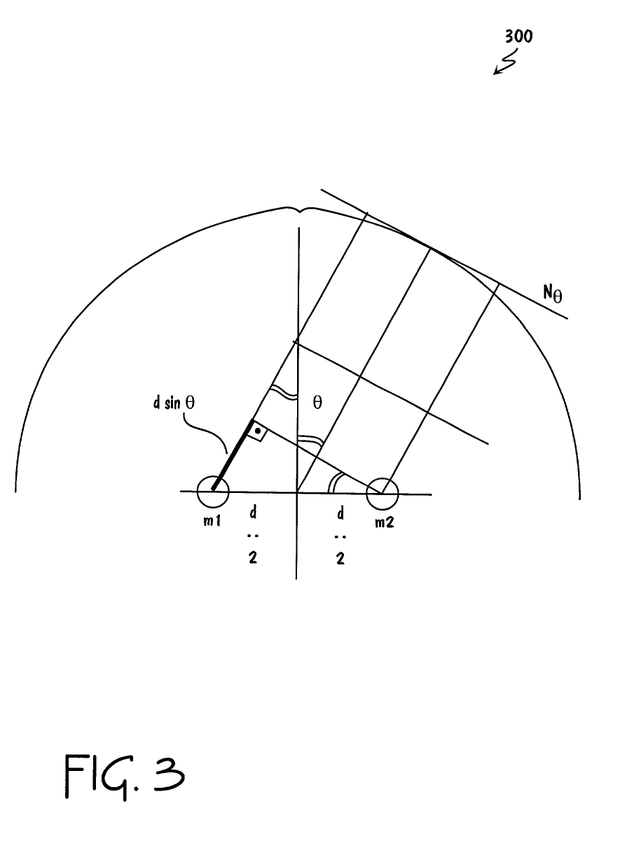

FIG. 2 shows an arrangement 200 of two microphones of an embodiment that satisfies the placement criteria. FIG. 3 is a detail view 300 of the two microphone arrangement of an embodiment. The single voice source is represented by S. Signals arriving from noise sources are represented by N. An analysis is now provided wherein the arrangement is shown to obey the placement criteria.

A primary signal source of interest S is located r units away from the first microphone (m₁) and r+d units away from the second microphone (m₂). Interfering with the source S are multiple noise sources, for example N₀ and N_{θ}, located at various distances from the microphones. The interfering noise sources are individually approximated by dummy noise sources N_{θ}, each located on a circle of radius R with its center at the second microphone (m₂). The subscript of the noise source designates its angular position (θ) namely the angle between the line of sight from the noise source to the midpoint of the line joining the two microphones and the line joining the two microphones.

Selection of the second microphone as the center is a matter of convenience and a way to designate the second microphone as the sum of all interfering sources. Note that this designation is not strict, as is the case with the source of interest, and does not imply that the signals generated by the noise sources arrive at the second microphone before they arrive at the first. In fact, when θ>180, the opposite is true. Furthermore, each of the dummy noise sources is assumed to be generating a planar wave front due to the distance of the actual noise source it is approximating. Each of the interfering dummy sources are R units away from the second microphone and R+d sin(θ) units away from the first microphone.

Given these approximations, the actual signals incident on each of the microphones are estimated as follows:

$${m}_{1} ( t ) = \frac{S ( t )}{r} + {\sum }_{θ} \frac{{N}_{θ} ( t - \frac{d sin ( θ )}{v} )}{R + d sin ( θ )}$$

$${m}_{2} ( t ) = \frac{S ( t - \frac{d}{v} )}{r + d} + {\sum }_{θ} \frac{{N}_{θ} ( t )}{R}$$

where ν is the velocity of the propagating sound wave. It is seen from these equations that the two microphones have different linear combinations of the single source of interest and the sum of all interfering sources. The first output channel is designated as the output that most closely captures the source of interest by designating the first microphone as “the source of interest microphone”. Thus, the first and third placement criteria are easily satisfied. The degree to which the second criterion, namely registering the sum of interfering sources as similarly as possible, is satisfied is a function of the distance between the two microphones, d. Making d small would help the second criterion, but might compromise the first and third criteria. Thus, the selection of the value for d is a trade-off between these conflicting constraints. In practice, distances substantially in the range from 0.5 inches to 4 inches have been found to yield satisfactory performance.

Application of the placement criteria to placement of more than two microphones requires the criteria to be revised for multiple sources of interest and an arrangement for more than two microphones. The first criterion is revised to include the need to have different linear combinations of the multiple sources of interest and the sum of all interfering sources. The second criterion is revised to include the need to register the sum of interfering sources as similarly as possible, so that one sum closely resembles the other. The third criteria is revised to include the need to designate a set of the multiple output channels as the outputs that most closely capture the multiple source of interest and label each channel per its corresponding source of interest. Further analysis and experimentation with a set of specific microphone types and directivity patterns, placement positions, and attitude with respect to signal propagation and target acoustic environment supports a determination of specific arrangements and spacing that are suitable or optimal for voice extraction using more than two microphones.

In the context of many applications, voice extraction is implemented as a signal processing system composed of FIR and/or IIR filters. To be realizable as an analog or digital signal processing system composed of FIR or IIR filters, a system has to obey causality. A technique for maintaining causality at all times is now described.

With reference to FIG. 3, for interfering noise sources N_{θ} where 180<θ<360, the quantity d sin(θ)<0. In this case the summed element N_{θ} in the first microphone equation references a time instant in the future and, thus, not yet available. This breach of causality can be remedied by appropriately delaying the first microphone signal. If the first microphone is delayed by the amount d/ν, then the microphone equations is written as:

$${m}_{1} ( t - \frac{d}{v} ) = \frac{S ( t - \frac{d}{v} )}{r} + {\sum }_{θ} \frac{{N}_{θ} ( t - \frac{d sin ( θ )}{v} - \frac{d}{v} )}{R + d sin ( θ )}$$

$${m}_{2} ( t ) = \frac{S ( t - \frac{d}{v} )}{r + d} + {\sum }_{θ} \frac{{N}_{θ} ( t )}{R}$$

Now two time-delayed versions of the speech source and the first microphone are defined as:

$${S}^{′} ( t ) = S ( t - \frac{d}{v} )$$

$${m}_{1}^{′} ( t ) = {m}_{1} ( t - \frac{d}{v} )$$

With these definitions the new equations for the microphone signals can be written as:

$${m}_{1}^{′} ( t ) = \frac{{S}^{′} ( t )}{r} + {\sum }_{θ} \frac{{N}_{θ} ( t - \frac{d ( 1 + sin ( θ ) )}{v} )}{R + d sin ( θ )}$$

$${m}_{2} ( t ) = \frac{{S}^{′} ( t )}{r + d} + {\sum }_{θ} \frac{{N}_{θ} ( t )}{R}$$

Since (1+sin(θ)) is always greater than or equal to zero, with the delay compensation modification, all terms reference present or past time instances and thus uphold the causality constraint. With this method an increase can be had in the number of voice (or other sound) sources of interest which can be extracted.

The voice extraction system of an embodiment, using blind signal separation, processes information from at least two signals. This information is received using two microphones. As many voice signal processing systems may only accommodate up to two microphones, a number of two-microphone placements are provided in accordance with the techniques presented herein.

The two-microphone arrangements provided herein discriminate between the voice of a single speaker and the sum of all other sound sources present in the environment, whether environmental noise, mechanical sounds, wind noise, other voices, and other sound sources. The position of the user is expected to be within a range of locations.

It is noted that the microphone elements are depicted using hand-held microphone icons. This is for illustration purposes only, as it easily supports depiction of the microphone axis. The actual microphone elements are any of a number of configurations found in the art, comprising elements of various sizes and shapes.

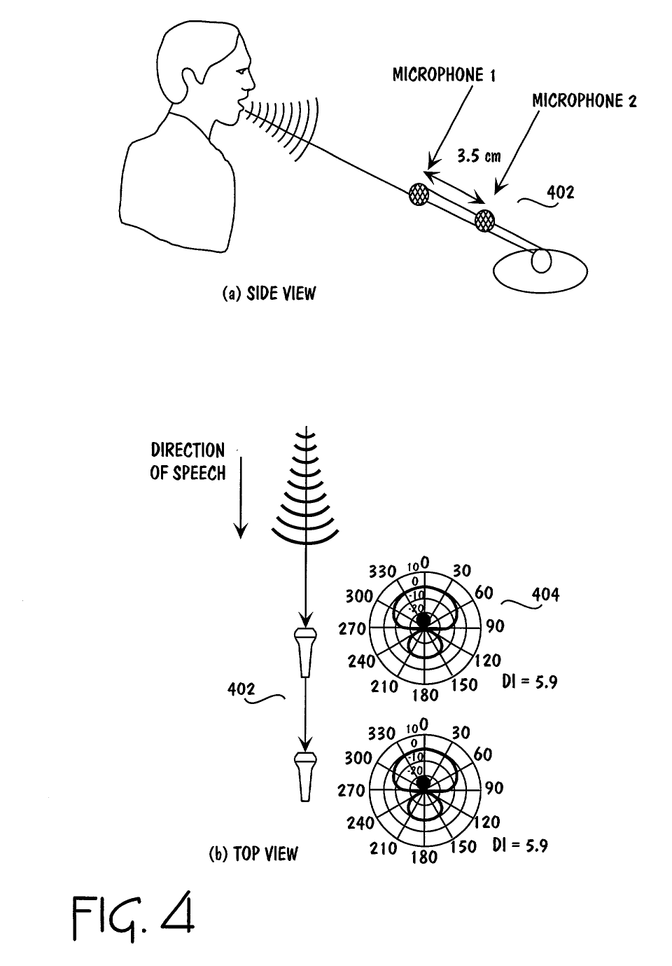

FIGS. 4A and 4B show a two-microphone arrangement 402 of a voice extraction system of an embodiment. FIG. 4A is a side view of the two-microphone arrangement 402, and FIG. 4B is a top view of the two-microphone arrangement 402. This arrangement 402 shows two microphones where both have a hypercardioid sensing pattern 404, but the embodiment is not so limited as one or both of the microphones can have one of or a combination of numerous sensing patterns including omnidirectional, cardioid, or figure eight sensing patterns. The spacing is designed to be approximately 3.5 cm. In practice, spacings substantially in the range 1.0 cm to 10.0 cm have been demonstrated.

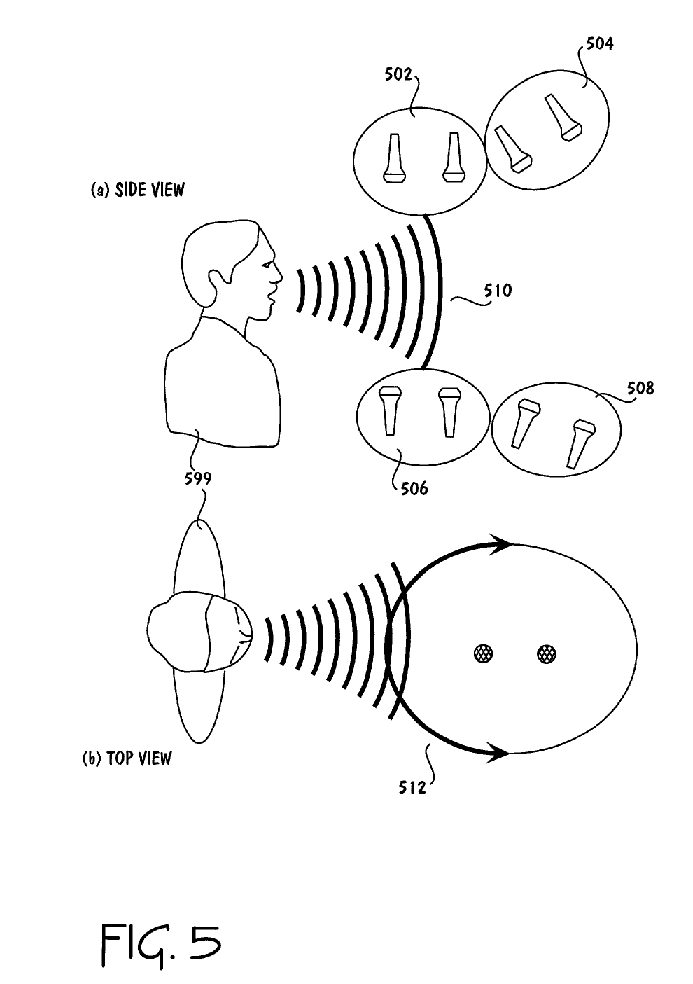

FIGS. 5A and 5B show alternate two-microphone arrangements 502-508 of a voice extraction system of an embodiment. FIG. 5A is a side view of the microphone arrangements 502-508, and FIG. 5B is a top view of the microphone arrangements 502-508. Each of these microphone arrangements 502-508 place the microphone axes perpendicular or nearly perpendicular to the direction of sound wave propagation 510. Further, each of the four microphone pair arrangements 502-508 provide options for which one microphone is closer to the signal source 599. Therefore, the closer microphone receives a voice signal with greater power earlier than the distant microphone receives the voice signal with diminished power. Using these arrangements, the sound source 599 can assume a broad range of positions along an arc 512 spanning 180 degrees around the microphones 502-508.

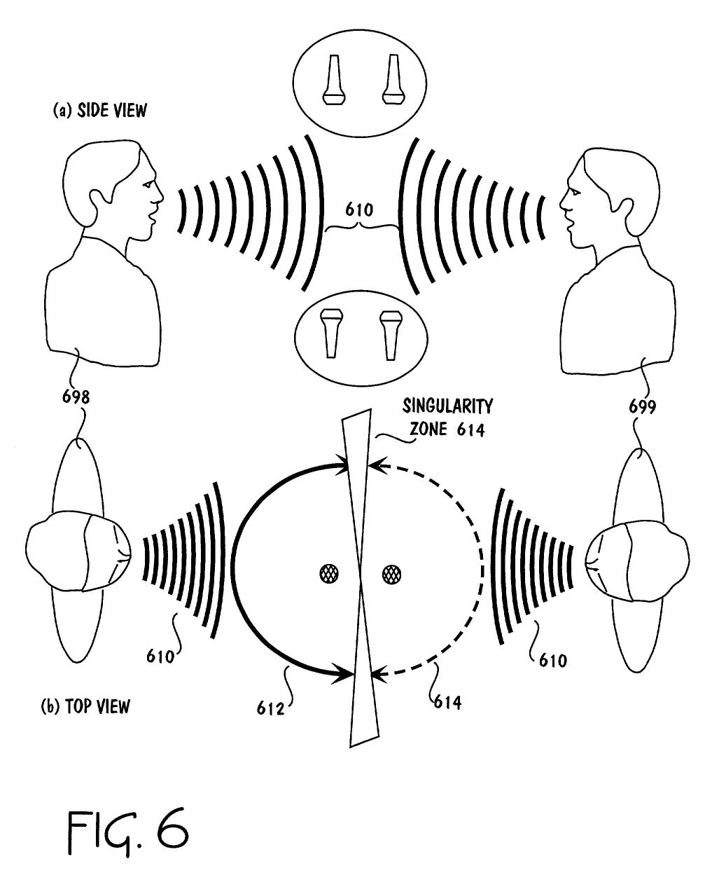

FIGS. 6A and 6B show additional alternate two-microphone arrangements 602-604 of a voice extraction system of an embodiment. FIG. 6A is a side view of the microphone arrangements 602-604, and FIG. 6B is a top view of the microphone arrangements 602-604. These two microphone arrangements 602-604 support the approximately simultaneous extraction of two voice sources 698 and 699 of interest. Either voice can be captured when both voices are active at the same time; furthermore, both of the voices can be simultaneously captured.

These microphone arrangements 602-604 also place the microphone axes perpendicular or nearly perpendicular to the direction of sound wave propagation 610. Further, each of the microphone pair arrangements 602-604 provide options for which a first microphone is closer to a first signal source 698 and a second microphone is closer to a second signal source 699. This results in the second microphone serving as the distant microphone for the first source 698 and the first microphone serving as the distant microphone for the second source 699. Therefore, the closer microphone to each source receives a signal with greater power earlier than the distant microphone receives the same signal with diminished power. Using this arrangement 602-604, the sound sources 698 and 699 can assume a broad range of positions along each of two arcs 612 and 614 spanning 180 degrees around the microphones 602-604. However, for best performance the sound sources 698 and 699 should not both be in the singularity zone 616 at the same time.

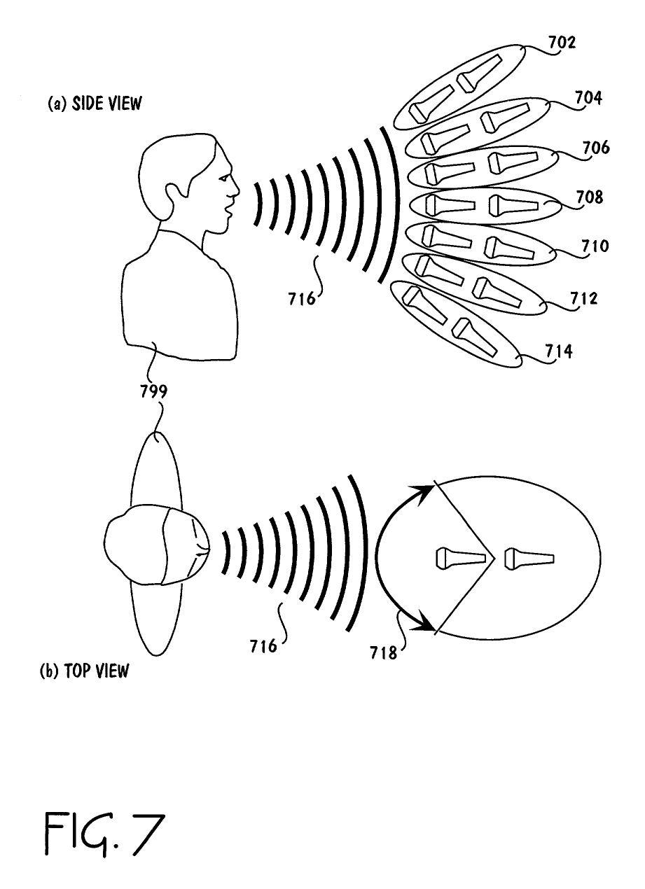

FIGS. 7A and 7B show further alternate two-microphone arrangements 702-714 of a voice extraction system of an embodiment. FIG. 7A is a side view of the seven microphone arrangements 702-714, and FIG. 7B is a top view of the microphone arrangements 702-714. These microphone arrangements 702-714 place the microphone axes parallel or nearly parallel to the direction of sound wave propagation 716. Further, each of the seven microphone pair arrangements 702-714 provide options for which one microphone is closer to the signal source 799. Therefore, the closer microphone receives a voice signal with greater power earlier than the distant microphone receives the voice signal with diminished power. Using these arrangements 702-714, the sound source 799 can assume a broad range of positions along an arc 718 spanning a range of approximately 90 to 120 degrees around the microphones 702-714.

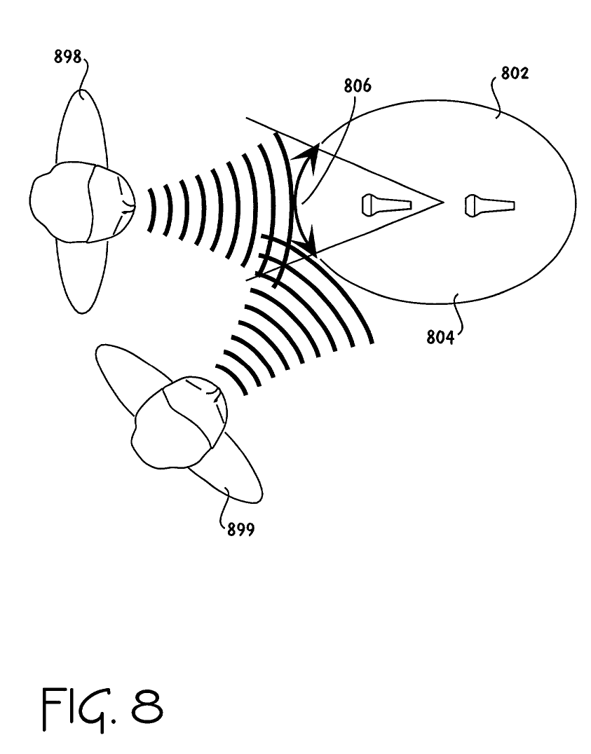

These microphone arrangements 702-714 further support the approximately simultaneous extraction of two voice sources of interest. Either voice can be captured when both voices are active at the same time; furthermore, both of the voices can be simultaneously captured. FIG. 8 is a top view of one 802 of these microphone arrangements 702-714 of an embodiment showing source placement 898 and 899 relative to the microphones 802. Using any one 802 of these seven arrangements 702-714, one sound source 899 can assume a broad range of positions along an arc 804 spanning approximately 270 degrees around the microphone array 802. The second sound source 898 is confined to a range of positions along an arc 806 spanning approximately 90 degrees in front of the microphone array 802. Angular separation of the two voice sources 898 and 899 can be smaller with increasing spacing between the two microphones 802.

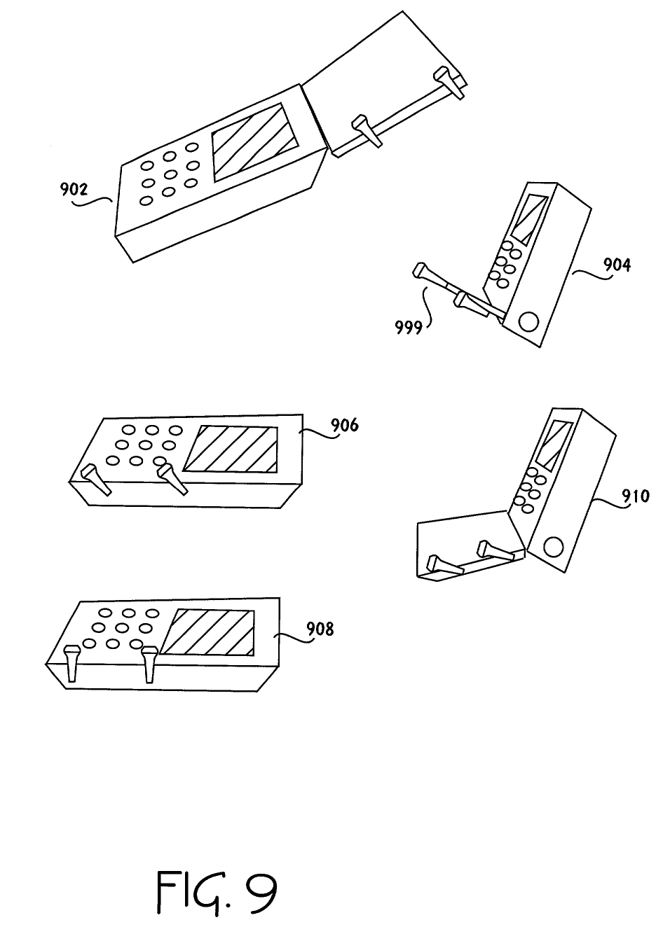

The voice extraction system of an embodiment can be used with numerous speech processing systems and devices including, but not limited to, hand-held devices, vehicle telematic systems, computers, cellular telephones, personal digital assistants, personal communication devices, cameras, helmet-mounted communication systems, hearing aids, and other wearable sound enhancement, communication, and voice-based command devices. FIG. 9 shows microphone array placement 999 of an embodiment on various hand-held devices 902-910.

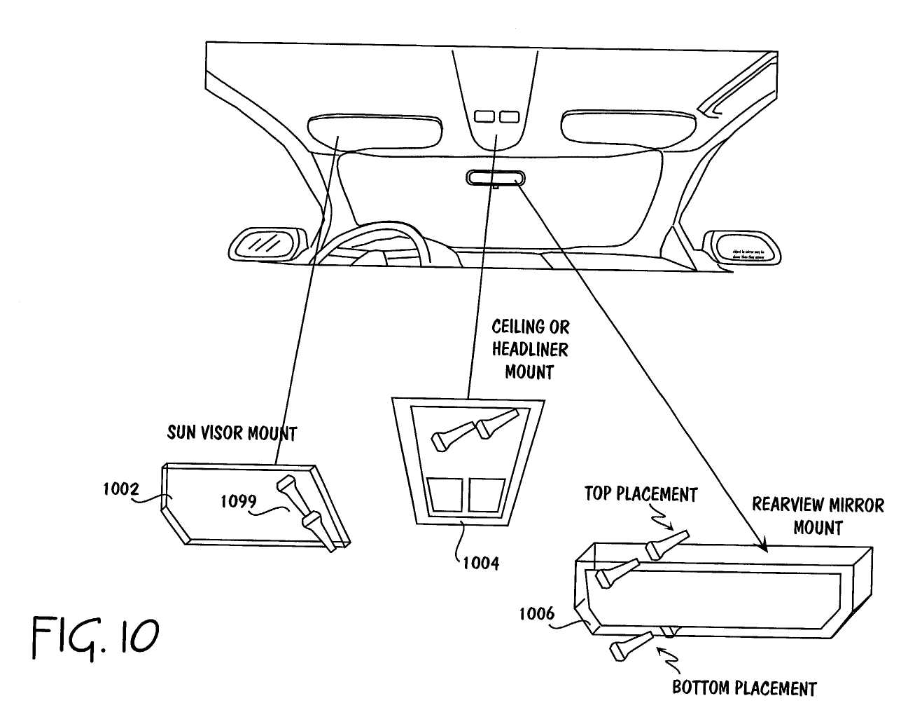

FIG. 10 shows microphone array 1099 placement of an embodiment in an automobile telematics system. Microphone array placement within the vehicle can vary depending on the position occupied by the source to be captured. Further, multiple microphone arrays can be used in the vehicle, with placement directed at a particular passenger position in the vehicle. Microphone array locations in an automobile include, but are not limited to, pillars, visor devices 1002, the ceiling or headliner 1004, overhead consoles, rearview mirrors 1006, the dashboard, and the instrument cluster. Similar locations could be used in other vehicle types, for example aircraft, trucks, boats, and trains.

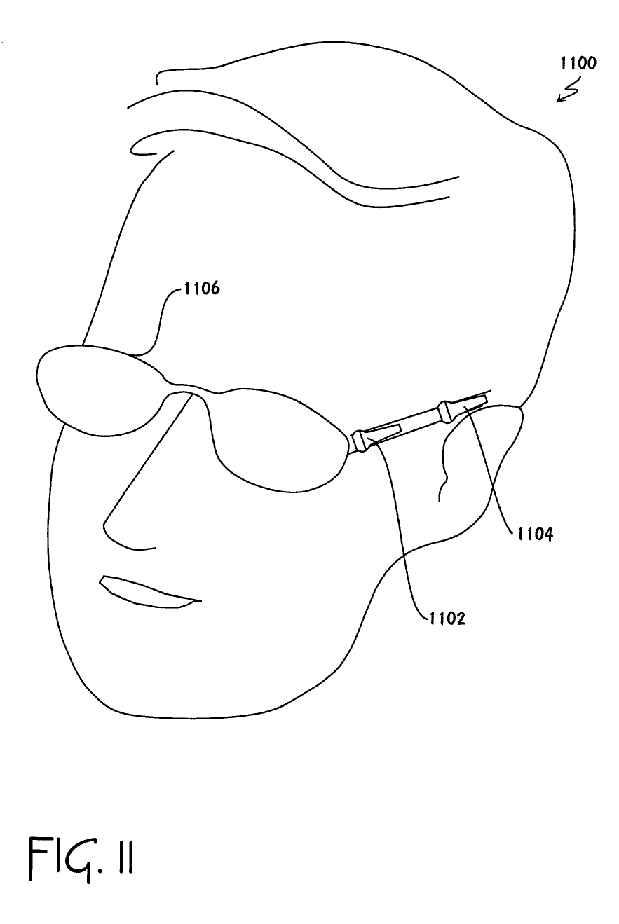

FIG. 11 shows a two-microphone arrangement 1100 of a voice extraction system of an embodiment mounted on a pair of eye glasses 1106 or goggles. The two-microphone arrangement 1100 includes microphone elements 1102 and 1104. This microphone array 1100 can be part of a hearing aid that enhances a voice signal or sound source arriving from the direction which the person wearing the eye glasses 1106 faces.

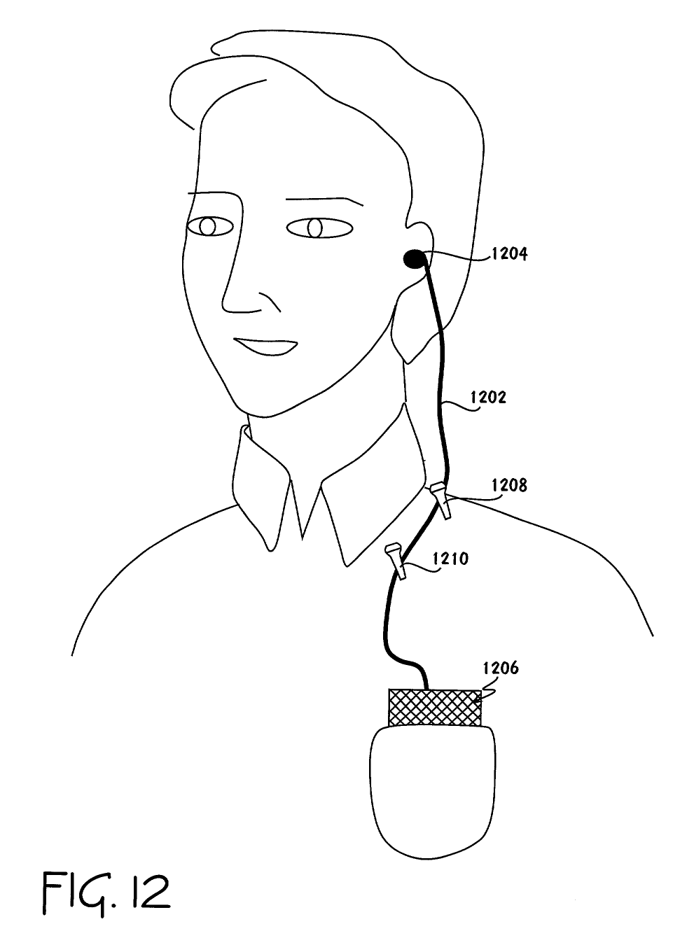

FIG. 12 shows a two-microphone arrangement 1200 of a voice extraction system of an embodiment mounted on a cord 1202. An earpiece 1204 communicates the audio signal played back or received by device 1206 to the ear of the user. The two microphones 1208 and 1210 are the two inputs to the voice extraction system enhancing the user's voice signal which is input to the device 1206.

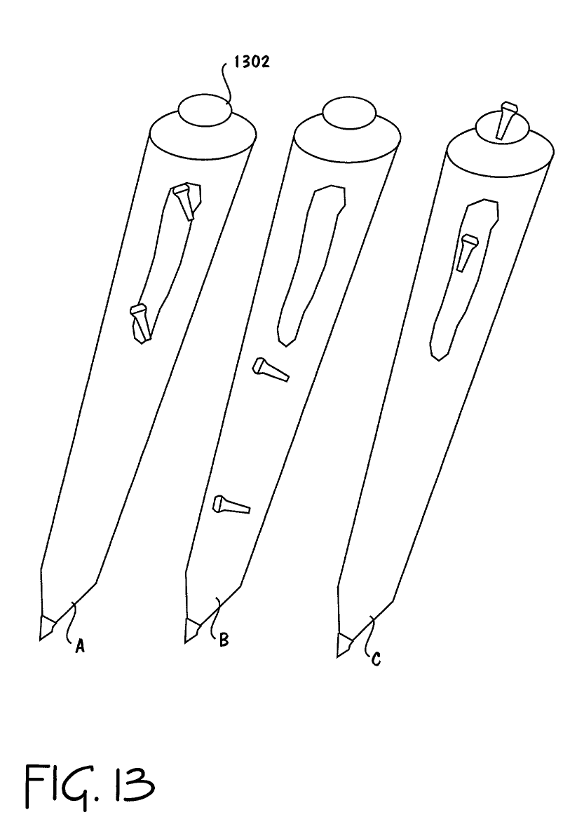

FIGS. 13A, B, and C show three two-microphone arrangements of a voice extraction system of an embodiment mounted on a pen 1302 or other writing or pointing instrument. The pen 1302 can also be a pointing device, such as a laser pointer used during a presentation.

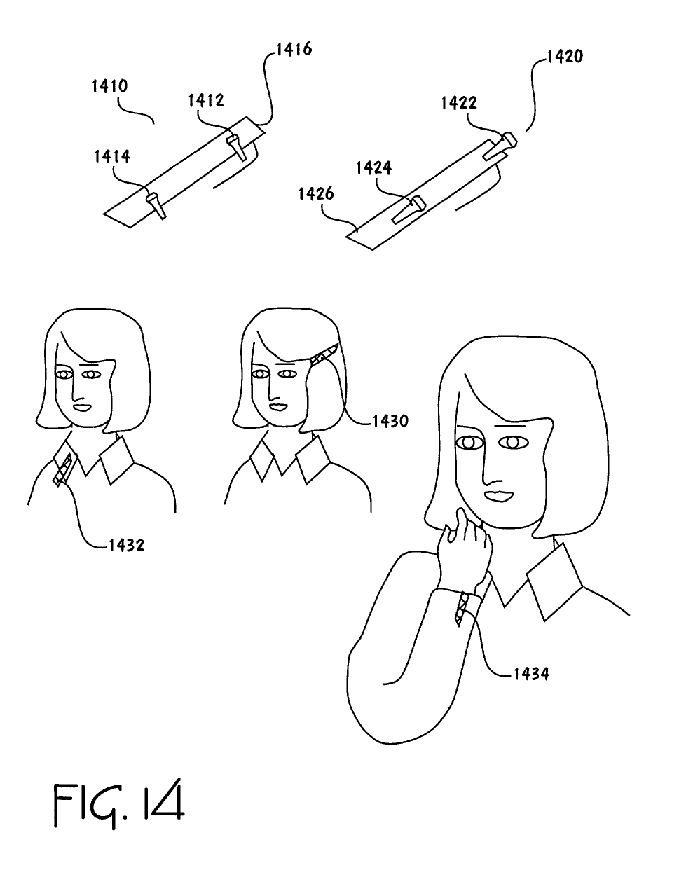

FIG. 14 shows numerous two-microphone arrangements of a voice extraction system of an embodiment. One arrangement 1410 includes microphones 1412 and 1414 having axes perpendicular to the axis of the supporting article 1416. Another arrangement 1420 includes microphones 1422 and 1424 having axes parallel to the axis of the supporting article 1426. The arrangement is determined based on the location of the supporting article relative to the sound source of interest. The supporting article includes a variety of pins that can be worn on the body 1430 or on an article of clothing 1432 and 1434, but is not so limited. The manner in which the pin can be worn includes wearing on a shirt collar 1432, as a hair pin 1430, and on a shirt sleeve 1434, but are not so limited.

Extension of the two microphone placement criteria also provides numerous microphone placement arrangements for microphone arrays comprising more than two microphones. As with the two microphone arrangements, the arrangements for more than two microphones can be used for discriminating between the voice of a single user and the sum of all other sound sources present in the environment, whether environmental noise, mechanical sounds, wind noise, or other voices.

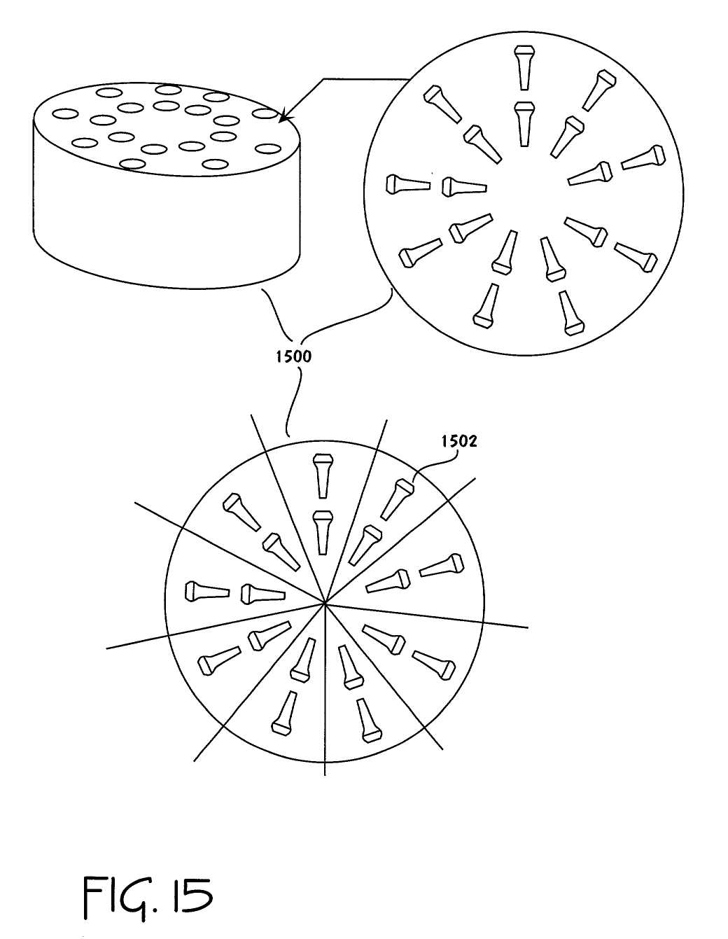

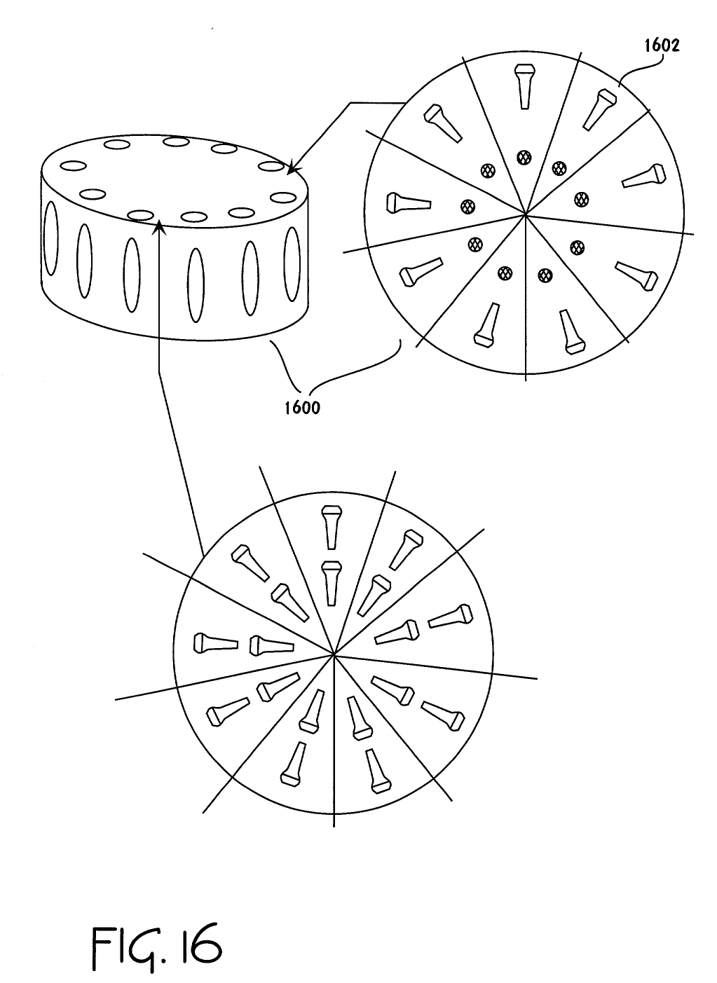

FIGS. 15 and 16 show microphone arrays 1500 and 1600 of an embodiment comprising more than two microphones. The arrays 1500 and 1600 are formed using multiple two-microphone elements 1502 and 1602. Microphone elements positioned directly behind one another function as a two-microphone element dedicated to voice sources emanating from an associated zone around the array. These embodiments 1500 and 1600 include nine two-microphone elements, but are not so limited. Voices from nine speakers (one per zone) can be simultaneously extracted with these arrays 1500 and 1600. The number of voices extracted can further be increased to 18 when causality is maintained. Alternately, a set of nine or less speakers can be moved within a zone or among zones.

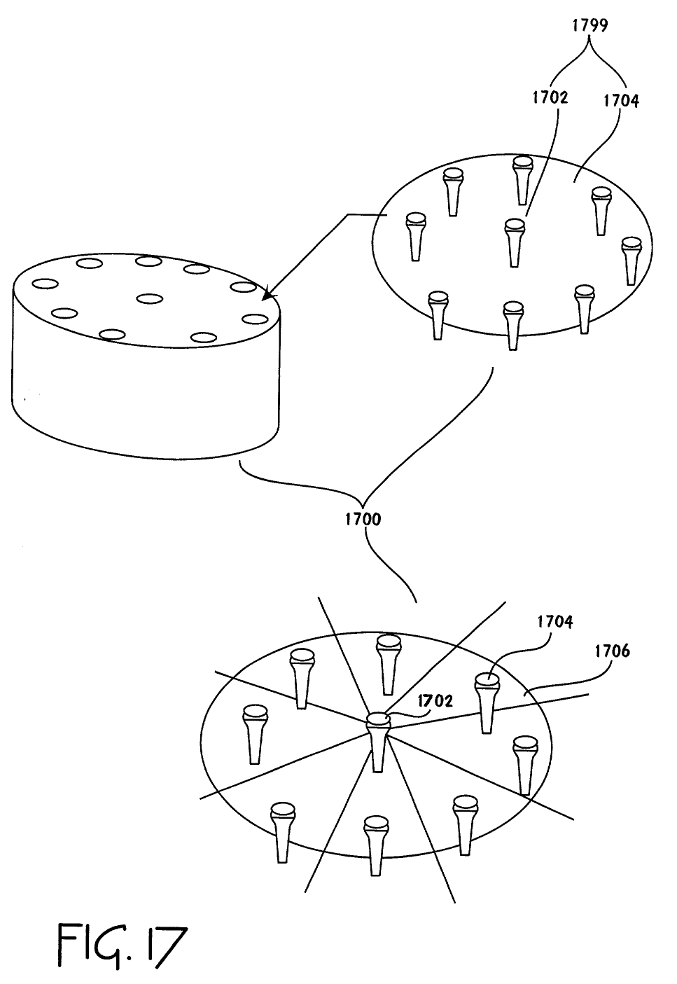

FIG. 17 shows an alternate microphone array 1700 of an embodiment comprising more than two microphones. This array 1700 is also formed by placing microphones in a circle. When paired with a center microphone 1702 of the array, a microphone on the array perimeter 1704 and the microphone in the center 1702 function as a two-microphone element 1799 dedicated to voice sources emanating from an associated zone 1706 around the array. However, in this array the center microphone element 1702 is common to all two-microphone elements. This embodiment includes microphone elements 1799 supporting eight zones 1706, but is not so limited. Voices from eight speakers (one per zone) can be simultaneously extracted with this array 1700. The number of voices extracted can further be increased to 16 (two per zone) when causality is maintained. Alternately, a set of eight or less speakers can be moved within a zone or among zones.

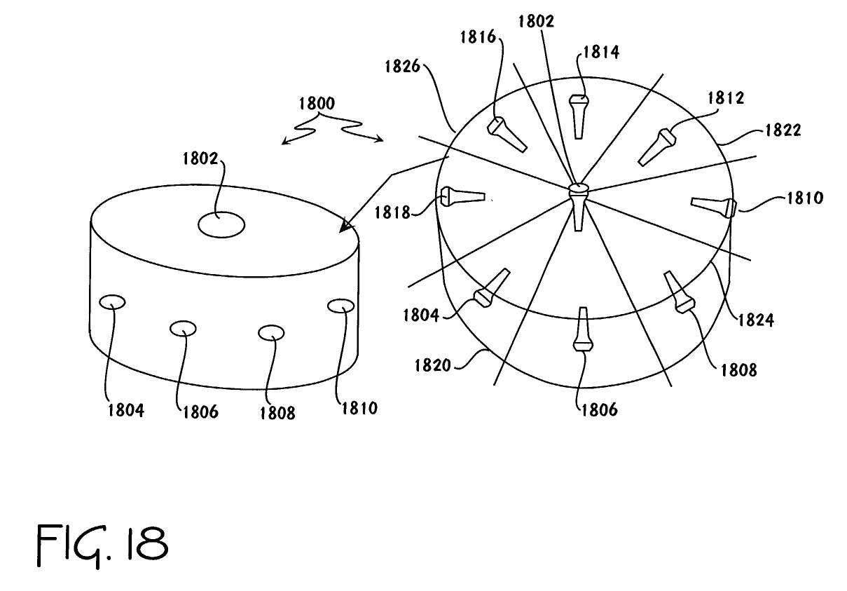

FIG. 18 shows another alternate microphone array 1800 of an embodiment comprising more than two microphones. This array 1800 is also formed in a manner similar to the arrangement shown in FIG. 17, but the microphones along the circle have their axes pointing in a direction away from the center of the circle. The microphone elements 1802/1804 function as a two-microphone element dedicated to voice sources emanating from an associated zone 1820 around the array 1800. In this arrangement, as in the arrangement shown in FIG. 17, center microphone element 1802 is common to the pair that the center microphone makes with the surrounding microphone elements. There are eight two-microphone element pairs as follows: 1804/1802, 1806/1802, 1808/1802, 1810/1802, 1812/1802, 1814/1802, 1816/1802, and 1818/1802. This embodiment uses the nine elements 1802, 1804, 1806, 1808, 1810, 1812, 1814, 1816, and 1818 to support eight zones, but is not so limited. For example, microphone elements 1802/1804 support voice extraction from region 1820; microphone elements 1802/1808 support voice extraction from region 1824; microphone elements 1802/1812 support voice extraction from region 1822; microphone elements 1802/1816 support voice extraction from zone 1826, and so on. Thus, voices from eight speakers (one per zone) can be simultaneously extracted with this array 1800. The number of voices extracted can further be increased to 16 when causality is maintained. Alternately, a set of eight or less speakers can be moving within a zone or among zones.

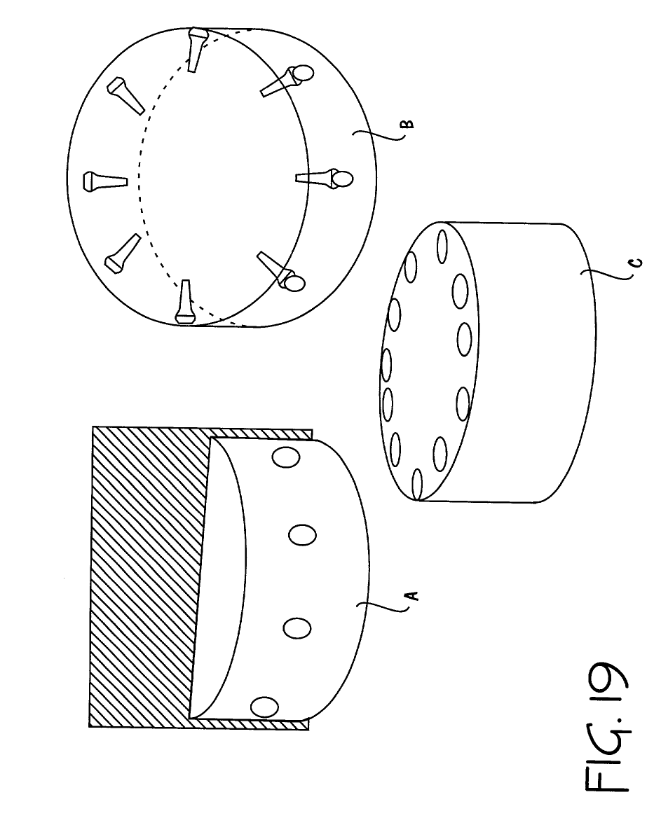

There is another way in which the array 1800 can be used. One can pair microphone 1804 with microphone 1812 to cover zones 1820 and 1822. This eliminates the need for the microphone in the center, which leads to the arrangements shown in FIGS. 19A-19C.

FIGS. 19A-C show other alternate microphone arrays of an embodiment comprising more than two microphones. The arrangements 19A-19C are similar to others discussed herein, but the central microphone or central ring of microphones is eliminated. Therefore, under most circumstances, a set of voices equal to or less than the number of microphone elements can be simultaneously extracted using this array. This is because in the most practical use of the three arrangements 19A-19C, a single sound source of interest is assigned to a single microphone, rather than a pair of microphones.

Arrangement 19A includes four microphones arranged along a semicircular arc with their axes pointing away from the center of the circle. The backside of the microphone arrangement 19A is mounted against a flat surface. Each microphone covers a 45 degree segment or portion of the semicircle. The number of microphones can be increased to yield a higher resolution. Each microphone element can be designated as the primary microphone of the associated zone. Any two or three or all of the microphones can be used as inputs to a two or three or four input voice extraction system. If the number of microphones are a number N greater than four, again any two, three, or more, up to N microphones can be used as inputs to a two, three, or more, up to N input voice extraction system. Arrangement 19A can extract four voices, one per zone. If the number of microphones are increased to N, N zones each spanning 180/N degrees can be covered and N voices can be extracted.

Arrangement 19B is similar to 19A, but contains eight microphones along a circle instead of four along a semicircle. Arrangement 19B can cover eight zones spanning 45 degrees each.

Arrangement 19C contains microphones whose axes are pointing up. Arrangement 19C may be used when the microphone arrangement must be flush with a flat surface, with no protrusions. Arrangement 19C of an embodiment includes eleven microphones that can be paired in 55 ways and input to two input voice extraction systems. This may be a way of extracting more voices than the number of microphone elements in the array. The number of voices extracted from N microphones can further be increased to (N). (N−1) voices when causality is maintained, since N microphones can be paired in N×(N−1)/2 ways, and each pair can distinguish between two voices. Some pairings may not be used, however, especially if the two microphones in the pair are close to each other. Alternately, all microphones can be used as inputs to a 11-input voice extraction system.

The microphone arrays that include more than two microphones offer additional advantages in that they provide an expanded range of positions for a single user, and the ability to extract multiple voices of interest simultaneously. The range of voice source positions is expanded because the additional microphones remove or relax limitations on voice source position found in the two microphone arrays.

In the two-microphone array, the position of the user is expected to be within a certain range of locations. The range is somewhat dependent on the directivity pattern of the microphone used and the specific arrangement. For example, when the microphones are positioned parallel to sound wave propagation, the range of user positions that lead to good voice extraction performance is narrower than the range of user positions that result in good performance in the array having the microphones positioned perpendicular to sound wave propagation. This can be inferred from a comparison between FIG. 5 and FIG. 7. On the other hand, the offending sound sources can come closer to the voice source of interest. This can be inferred by comparing FIG. 6 and FIG. 8. In contrast, the microphone arrays having more than two microphones allow the voice source of interest to be located at any point along an arc that surrounds the microphone arrangement.

Regarding the ability to simultaneously extract multiple voices of interest, there was an assumption with the two microphone array that a single voice source of interest is present. While the two-microphone array can be extended to two voice sources of interest, the quality and efficiency of the extraction depends upon appropriate positioning of the sources. In contrast, the microphone array including more than two microphone elements reduces or eliminates the source position constraints.

Using the two-microphone arrangement described herein, architectural variations can be formulated for the voice extraction system. These extensions directly translate to alternate procedures for obtaining the voice or other sound or source signal of interest free of interference. Further, these architectural variations are especially useful for underdetermined systems, where the number of signals sources mixing together before they are registered by sensors are greater than the number of sensors or sensor elements that register them. These architectural extensions are also applicable to signals other than voice signals and sound signals. In that sense, the application domains of the signal separation architecture extensions have many applications that reach beyond voice extraction.

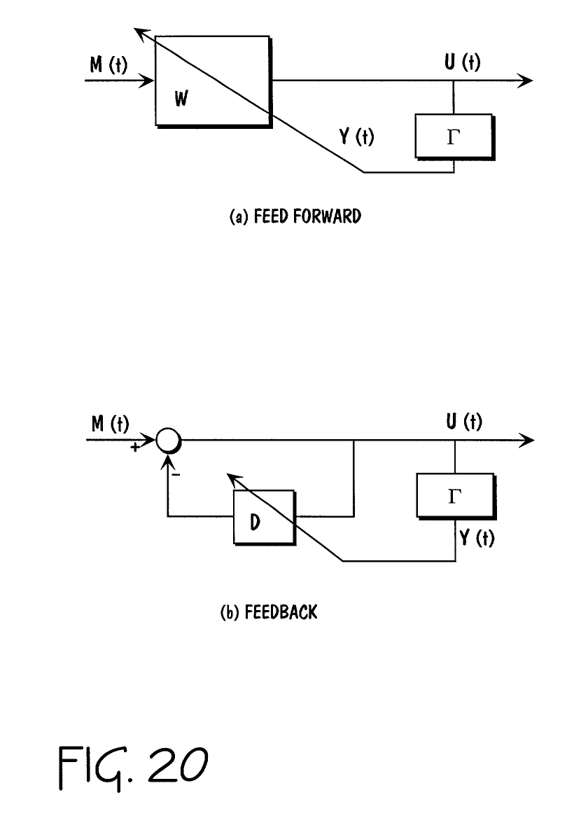

The extension is taken from simple representations of typical signal separation architectures. FIG. 20A shows a typical feedforward signal separation architecture. FIG. 20B shows a typical feedback signal separation architecture. In these systems, M(t) is a vector formed from the signals registered by multiple sensors. Further, Y(t) is a vector formed using the output signals. In symmetric architectures, M(t) and Y(t) have the same number of elements.

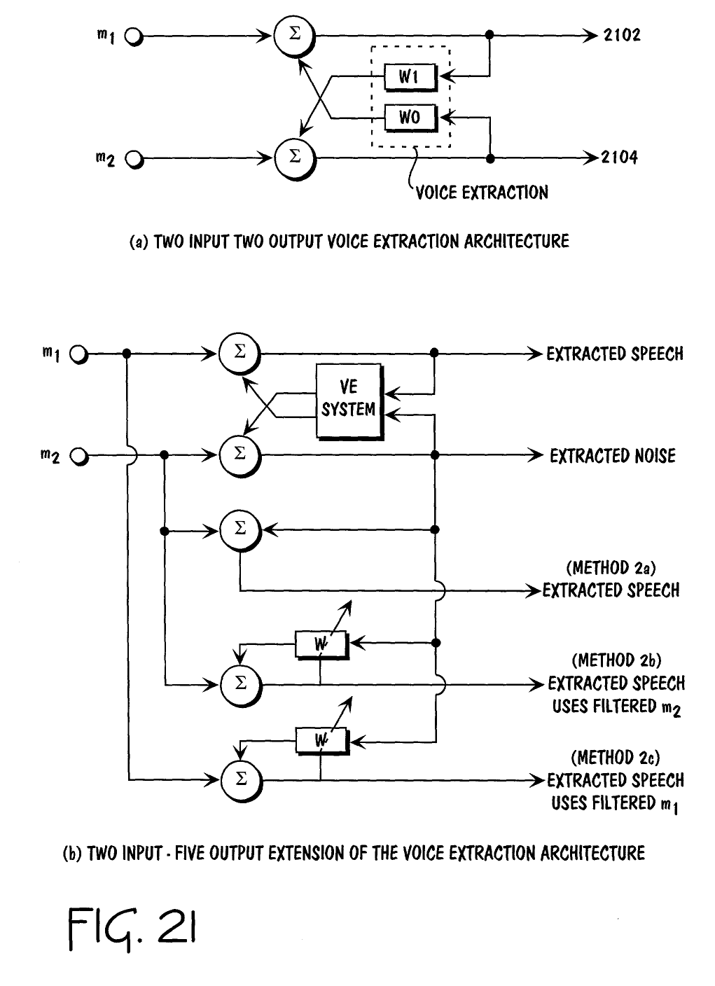

FIG. 21A shows a block diagram of a voice extraction architecture of an embodiment receiving two inputs and providing two outputs. Such a voice extraction architecture and resulting method and system can be used to capture the voice of interest in, for example, the scenario depicted in FIG. 2. Sensor m1 represents microphone 1, and sensor m2 represents microphone 2. In this case, the first output of the voice extraction system 2102 is the extracted voice signal of interest, and the second output 2104 approximates the sum of all interfering noise sources.

FIG. 21B shows a block diagram of a voice extraction architecture of an embodiment receiving two inputs and providing five outputs. This extension provides three alternate methods of computing the extracted voice signal of interest. One such procedure, Method 2a, is to subtract the second output, or extracted noise, from the second microphone (i.e., microphone 2—Extracted Noise). This approximates the speech signal, or signal of interest, content in microphone 2. When using this method the second microphone is placed further away from the speaker's mouth and thus may have a lower signal-to-noise ratio (SNR) for the source signal of interest. In experiments conducted using this approach, in many cases where multiple sources were interfering with a single voice signal, the speech output using Method 2a provided a better SNR.

Method 2b is very similar to Method 2a, except that a filtered version of the extracted noise is subtracted from the second microphone to more precisely match the noise component of the second microphone. In many noise environments this method approximates the signal of interest much better than the simple subtraction approach of Method 2a. The type of filter used with Method 2b can vary. One example filter type is a Least-Mean-Square (LMS) adaptive filter, but is not so limited. This filter optimally filters the extracted noise by adapting the filter coefficients to best reduce the power (autocorrelation) of one or more error signals, such as the difference signal between the filtered extracted noise and the second microphone input. Typically, the speech (signal of interest) component of the second microphone is uncorrelated with the noise in that microphone signal. Therefore, the filter adapts only to minimize the remaining or residual noise in the Method 2b extracted speech output signal.

Method 2c is similar to Method 2b with the exception that the filtered extracted noise is subtracted from the first microphone instead of the second. This method has the advantage of a higher starting SNR since the first microphone is now being used, the microphone that is closer to the speaker's mouth. One drawback of this approach is that the extracted noise derived from the second microphone is less similar to that found on microphone one and requires more complex filtering.

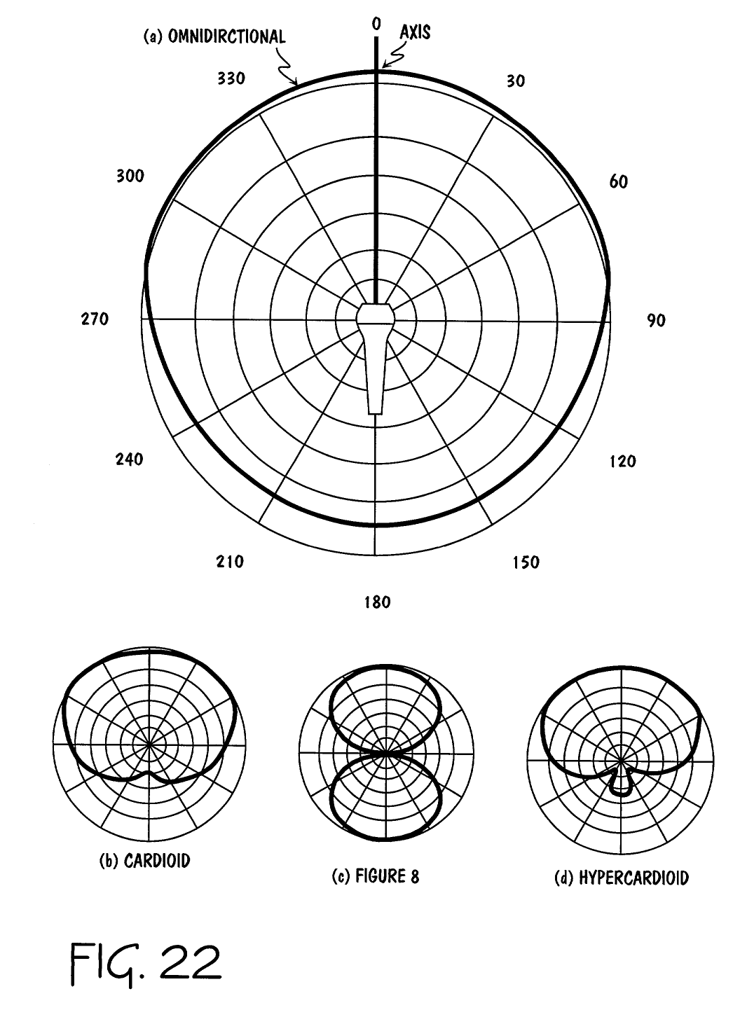

It is noted that all microphones or sound sensing devices have one or more polar patterns that describe how the microphones receive sound signals from various directions. FIGS. 22A-D show four types of microphone directivity patterns used in an embodiment. The microphone arrays of an embodiment can accommodate numerous types and combinations of directivity patterns, including but not limited to these four types.

FIG. 22A shows an omnidirectional microphone signal sensing pattern. An omnidirectional microphone receives sound signals approximately equally from any direction around the microphone. The sensing pattern shows approximately equal amplitude received signal power from all directions around the microphone. Therefore, the electrical output from the microphone is the same regardless of from which direction the sound reaches the microphone.

FIG. 22B shows a cardioid microphone signal sensing pattern. The kidney-shaped cardioid sensing pattern is directional, providing fill sensitivity (highest output from the microphone) when the source sound is at the front of the microphone. Sound received at the sides of the microphone (±90 degrees from the front) has about half of the output, and sound appearing at the rear of the microphone (180° from the front) is attenuated by approximately 70%-90%. A cardioid pattern microphone is used to minimize the amount of ambient (e.g., room) sound in relation to the direct sound.

FIG. 22C shows a figure-eight microphone signal sensing pattern. The figure-eight sensing pattern is somewhat like two cardioid patterns placed back-to-back. A microphone with a figure-eight pattern receives sound equally at the front and rear positions while rejecting sounds received at the sides.

FIG. 22D shows a hypercardioid microphone signal sensing pattern. The hypercardioid sensing pattern produces fall output from the front of the microphone, and lower output at ±90 degrees from the front position, providing a narrower angle of primary sensitivity as compared to the cardioid pattern. Furthermore, the hypercardioid pattern has two points of minimum sensitivity, located at approximately ±140 degrees from the front. As such, the hypercardioid pattern suppresses sound received from both the sides and the rear of the microphone. Therefore, hypercardioid patterns are best suited for isolating instruments and vocalists from both the room ambience and each other.

The methods or techniques of the voice extraction system of an embodiment are embodied in machine-executable instructions, such as computer instructions. The instructions can be used to cause a processor that is programmed with the instructions to perform voice extraction on received signals. Alternatively, the methods of an embodiment can be performed by specific hardware components that contain the logic appropriate for the methods executed, or by any combination of the programmed computer components and custom hardware components. Furthermore, the voice extraction system of an embodiment can be used in distributed computing environments.

The description herein of various embodiments of the invention has been presented for purpose of illustration and description. It is not intended to limit the invention to the precise forms disclosed. Many modifications and equivalent arrangements will be apparent.

What is claimed is:

1. A method for positioning individual receiver elements of an arrangement, wherein the arrangement includes at least two receiver elements providing at least two inputs to a signal processing system, comprising:
identifying at least one location of a source of at least one signal of interest;
determining a position for at least one first receiver element;
generating a set of criteria in response to characteristics of the at least one signal of interest, wherein the set of criteria provide satisfactory performance of the signal processing system; and
determining a position of at least one additional receiver element relative to the at least one first receiver element in response to the set of criteria.

2. The method of claim 1, wherein the set of criteria includes disqualification of receiver element placements that lead to identical signals being registered by more than a specified number of the individual receiver elements.

3. The method of claim 1, wherein the signal processing system distinguishes among the at least one signal of interest and at least one interfering signal using at least one input signal registered by the at least two receiver elements.

4. The method of claim 3, wherein the set of criteria includes positioning the individual receiver elements so that a sum of interfering signals that are registered by the at least two receiver elements have similar characteristics.

5. The method of claim 3, wherein the spacing between the at least two receiver elements is approximately in the range of 0.5 inches to 5 inches.

6. The method of claim 3, wherein the at least two receiver elements comprise at least two microphone elements.

7. The method of claim 6, wherein a primary axis of each of the at least two microphone elements is approximately perpendicular to a direction of sound wave propagation from the at least one signal of interest.

8. The method of claim 6, wherein a primary axis of each of the at least two microphone elements is approximately parallel to a direction of sound wave propagation from the at least one signal of interest.

9. The method of claim 6, wherein a primary axis of one of the at least two microphone elements is approximately perpendicular to a direction of sound wave propagation from the at least one signal of interest and a primary axis of another of the at least two microphone elements is approximately parallel to the direction of sound wave propagation from the at least one signal of interest.

10. The method of claim 1, wherein the individual receiver elements are coupled to at least one device selected from a group consisting of computers, monitors, hand-held computing devices, hearing aids, vehicle telematic systems, cellular telephones, personal digital assistants, and communication devices.

11. The method of claim 1, wherein the individual receiver elements coupled to the vehicle telematic systems are located in at least one vehicle component selected from a group consisting of pillars, visors, headliners, overhead consoles, rearview mirrors, dashboards, and instrument clusters.

12. The method of claim 1, wherein the individual receiver elements are positioned on at least one item selected from a group consisting of pens, writing instruments, audio playback and recording devices, listening devices, headsets, earplugs, articles of clothing, eye glasses, hair accessories, watches, bracelets, earrings, jewelry, items that can be worn on a body, and items that can be worn on articles of clothing.

13. The method of claim 1, wherein the individual receiver elements are coupled to a device inserted in the ear canal.

14. A method for positioning a receiver array of a signal processing system, comprising:
identifying at least one location of sources of at least one signal of interest;
determining a position of at least one first receiver element of a receiver array relative to the at least one location, wherein the at least one first receiver element receives the at least one signal of interest first in time; and
determining a position of at least one second receiver element of the receiver array relative to the at least one first receiver element, wherein the at least one second receiver element receives the at least one signal of interest second in time, wherein a spacing between the at least one first and second receiver elements provides at least one time delay that supports generation of a plurality of linear combinations of the at least one signal of interest and a sum of interfering sources, and registration of a sum of interfering sources so that a first sum resembles a second sum.

15. The method of claim 14, wherein the spacing supports performing signal extraction on a plurality of delayed versions of at least one received signal.

16. The method of claim 14, wherein the at least one first receiver element comprises at least one first microphone and the at least one second receiver element comprises at least one second microphone.

17. The method of claim 16, further comprising isolating the at least one signal of interest using at least one inter-microphone differential in signal amplitude in each of the at least one first microphone and the at least one second microphone.

18. The method of claim 14, further comprising at least one first receiver element and at least one second receiver element corresponding to each of a plurality of sources.

19. The method of claim 14, further comprising at least one first receiver element corresponding to each of a plurality of sources, wherein the at least one second receiver element comprises one microphone element common to the plurality of sources.

20. The method of claim 14, wherein the at least one first receiver element receives at least one signal from a first source first in time and at least one signal from a second source second in time, wherein the at least one second receiver element receives the at least one signal from a second source first in time and the at least one signal from a first source second in time.

21. A method for extracting at least one signal of interest from a composite audio signal, comprising:
identifying at least one location of a source of at least one signal of interest;
determining a position for at least one first microphone element of a microphone arrangement relative to the at least one location;
generating a set of criteria in response to characteristics of the composite audio signal, wherein the set of criteria provide for satisfactory extraction of the signal of interest from the composite audio signal; and
determining a position of at least one additional microphone element of the microphone arrangement relative to the at least one first microphone element in response to the set of criteria.

22. The method of claim 21, wherein the set of criteria are replaced by a second set of criteria, wherein the second set of criteria provide for satisfactory removal of the signal of interest from the composite audio signal.

23. The method of claim 22, wherein the set of criteria are supplemented by the second set of criteria.

24. The method of claim 21, wherein the set of criteria include maintaining causality during signal extraction.

25. The method of claim 24, further comprising maintaining causality by delaying at least one input signal registered by at least one microphone element of the microphone arrangement.

26. A method for extracting at least one signal of interest from a composite audio signal, comprising:
determining a position of at least one first receiver element of a receiver array relative to at least one location of a source of the at least one signal of interest, wherein the at least one first receiver element receives the at least one signal of interest first in time;
determining a position of at least one second receiver element of the receiver array relative to the at least one first receiver element, wherein the at least one second receiver element receives the at least one signal of interest second in time, wherein a spacing between the at least one first and second receiver elements allows for generation of a plurality of linear combinations of the at least one source signal and a sum of interfering sources, and registration of a sum of interfering sources so that a first sum resembles a second sum;
receiving the composite audio signal using the receiver array; and
extracting the at least one signal of interest using at least one inter-receiver element differential in signal amplitude.

27. The method of claim 26, wherein the spacing supports performing signal extraction on a plurality of delayed versions of at least one received signal.

28. The method of claim 26, further comprising at least one first receiver element corresponding to each of a plurality of sources, wherein the at least one second receiver element comprises one microphone element common to the plurality of sources.

29. A microphone array for use with speech processing systems, comprising:
at least one first microphone element positioned to receive at least one signal of interest first in time from at least one source;
at least one second microphone element positioned to receive the at least one signal of interest second in time relative to the at least one first microphone element, wherein a spacing between the at least one first and second microphone elements allows for generation of a plurality of combinations of the at least one source signal, and a sum of interfering sources.

30. The microphone array of claim 29, wherein the spacing supports registration of a sum of interfering sources so that the sum registered by at least one microphone element resembles the sum registered by at least one other microphone element.

31. The microphone array of claim 29, wherein at least two microphone elements receive the at least one signal of interest at unknown times, wherein a delay is introduced to at least one received microphone signal prior to signal processing.

32. The microphone array of claim 31, wherein a delay of a first length is applied to a received signal of a first microphone element and a delay of a second length is applied to a received signal of a second microphone element.

33. The microphone array of claim 29, wherein the spacing is approximately in the range of 0.5 inches to 5 inches.

34. The microphone array of claim 29, further comprising at least one first microphone element and at least one second microphone element each corresponding to one of a set of signal sources of interest.

35. The microphone array of claim 29, further comprising at least one pair of microphone elements, wherein each pair of microphone elements corresponds to at least one signal source of interest.

36. The microphone array of claim 29, wherein at least one microphone element is common to at least two microphone pairs.

37. The microphone array of claim 29, further comprising at least one first microphone element corresponding to each of a plurality of sources, wherein the at least one second microphone element comprises one microphone element common to the plurality of sources.

38. The microphone array of claim 29, wherein the microphone array is coupled to at least one device selected from a group consisting of hand-held computing devices, hearing aids, vehicle telematic systems, cellular telephones, personal digital assistants, and communication devices.

39. The microphone array of claim 38, wherein the microphone array coupled to a vehicle telematic system is located in at least one vehicle component selected from a group consisting of pillars, visors, headliners, overhead consoles, rearview mirrors, dashboards, and instrument clusters.

40. The method of claim 29, wherein the microphone array is positioned on at least one item selected from a group consisting of pens, writing instruments, audio playback and recording devices, listening devices, headsets, earplugs, articles of clothing, eye glasses, hair accessories, watches, bracelets, earrings, jewelry, items that can be worn on a body, and items that can be worn on articles of clothing.

41. An audio signal processing system comprising:
at least one signal processor;
at least one microphone array coupled among at least one environment and the at least one signal processor, wherein the at least one signal processor extracts at least one signal of interest from a composite audio signal.

42. An audio signal processing system comprising:
at least one signal processor;
at least one microphone array coupled among at least one environment and the at least one signal processor, wherein the at least one microphone array comprises:
at least one first microphone element positioned to receive at least one signal of interest first in time from at least one source in the at least one environment,
at least one second microphone element positioned to receive the at least one signal of interest second in time relative to the at least one first microphone element, wherein a spacing between the at least one first and second microphone elements allows for generation of a plurality of linear combinations of the at least one source signal and a sum of interfering sources, and registration of a sum of interfering sources so that a first sum resembles a second sum.

43. A method for extracting at least one signal of interest from a composite audio signal using at least two microphone elements each corresponding to an input channel, comprising allocating contents of at least one input channel among at least two output channels, wherein at least one output channel of the at least two output channels includes a higher proportion of the at least one signal of interest than the at least one input channel.

44. The method of claim 43, wherein the at least one output channel contains a lower proportion of the at least one signal of interest than the at least one input channel.

45. The method of claim 43, wherein allocating includes at least one blind signal separation method.

46. The method of claim 43, wherein a number of input channels used varies in response to characteristics of the at least one input channel.

47. The method of claim 43, wherein a number of output channels used varies in response to characteristics of the at least one input channel or the at least one output channel.

48. The method of claim 43, wherein allocating includes at least one operation among at least one input channel and at least one other input channel.

49. The method of claim 43, wherein allocating includes at least one operation among a plurality of output channels.

50. The method of claim 43, wherein allocating includes at least one operation among the at least one input channel and the at least one output channel.

51. A computer readable medium including executable instructions which, when executed in a processing system, provides positioning information for a receiver arrangement of a signal processing system, the positioning information comprising:
identifying at least one location of a source of at least one signal of interest;
determining a position for at least one first receiver element;
generating a set of criteria in response to characteristics of the at least one signal of interest, wherein the set of criteria provide satisfactory performance of the signal processing system; and
determining a position of at least one additional receiver element relative to the at least one first receiver element in response to the set of criteria.

52. A computer readable medium including executable instructions which, when executed in a processing system, provides positioning information for a receiver array of a signal processing system, the positioning information comprising:
identifying at least one location of sources of at least one signal of interest;
determining a position of at least one first receiver element of a receiver array relative to the at least one location, wherein the at least one first receiver element receives the at least one signal of interest first in time; and
determining a position of at least one second receiver element of the receiver array relative to the at least one first receiver element, wherein the at least one second receiver element receives the at least one signal of interest second in time, wherein a spacing between the at least one first and second receiver elements provides at least one time delay that supports generation of a plurality of linear combinations of the at least one signal of interest and a sum of interfering sources, and registration of a sum of interfering sources so that a first sum resembles a second sum.

53. A computer readable medium including executable instructions which, when executed in a processing system, isolates at least one signal of interest from a composite audio signal, the isolation comprising:
determining a position of at least one first receiver element of a receiver array relative to at least one location of a source of the at least one signal of interest, wherein the at least one first receiver element receives the at least one signal of interest first in time;
determining a position of at least one second receiver element of the receiver array relative to the at least one first receiver element, wherein the at least one second receiver element receives the at least one signal of interest second in time, wherein a spacing between the at least one first and second receiver elements allows for generation of a plurality of linear combinations of the at least one source signal and a sum of interfering sources, and registration of a sum of interfering sources so that a first sum resembles a second sum;
receiving the composite audio signal using the receiver array; and
isolating the at least one signal of interest using at least one inter-receiver element differential in signal amplitude.

54. A computer readable medium including executable instructions which, when executed in a processing system, isolates at least one signal of interest from a composite audio signal, the isolation comprising:
coupling at least two microphone elements to at least one input channel; and
allocating contents of the at least one input channel among at least two output channels, wherein at least one output channel includes a higher proportion of the at least one signal of interest than the at least one input channel.

55. The computer readable medium of claim 54, wherein the at least one output channel includes a lower proportion of the at least one signal of interest than the at least one input channel.

56. The computer readable medium of claim 54, further comprising determining an approximate position of at least one location of a source of the at least one signal of interest relative to at least one microphone element of a microphone arrangement.

57. An electromagnetic medium including executable instructions which, when executed in a processing system, provides positioning information for a receiver arrangement of a signal processing system, the positioning information comprising:
identifying at least one location of a source of at least one signal of interest;
determining a position for at least one first receiver element;
generating a set of criteria in response to characteristics of the at least one signal of interest, wherein the set of criteria provide satisfactory performance of the signal processing system; and
determining a position of at least one additional receiver element relative to the at least one first receiver element in response to the set of criteria.
